(19) United States
(12) Patent Application Publication
(10) Pub. No.: US 2011/0222670 A1
(43) Pub. Date: Sep. 15, 2011

(54) ALERTING SYSTEM AND A METHOD OF ALERTING DESIGNATED PARTIES

(75) Inventors: L. Michael Sellers, Ridgefield, WA (US); William L. Hood, Houston, TX (US); Chris Giles, Sherwood, OR (US)

(73) Assignee: Telecom Technologies, LLC, Sherwood, OR (US)

(21) Appl. No.: 12/721,182

(22) Filed: Mar. 10, 2010

(51) Int. Cl. H04M 11/04; H04M 1/64

(52) U.S. Cl. 379/45; 379/88.12

(57) ABSTRACT

An alerting system is disclosed including in one embodiment: (1) a detection system configured to identify an initiated emergency call, identify a calling device initiating the emergency call and generate a detection message that identifies the calling device, the detection system implemented at central office equipment of a telephone company, (2) a determining system configured to receive the detection message, confirm if the calling device is registered with an alerting service and generate a confirmation message when the calling device is registered, the determining system configured to uniquely correspond with the telephone company and (3) a notification system configured to receive the confirmation message, determine parties associated with the calling device and contact the parties with a notification message, the notification message limited to information obtained concurrent with or before occurrence of the emergency call, the determining system and the notification system independent of the telephone company.

### TECHNICAL FIELD

This application is directed, in general, to contacting designated parties associated with a calling device, and more specifically, to contacting designated parties based on monitored telephone calls initiated by the calling device.

### BACKGROUND

Communications systems exist in the United States and in other countries that have a designated telephone number to report emergencies. The emergencies may be due to nature, crime, health, accidents, etc. By having the designated telephone number and a communications system in place, people can quickly report emergencies and obtain assistance from agencies that are trained to respond to the reported emergencies.

In addition to responding agencies, people that are possibly associated with the emergencies may also like to be notified. For example, a parent may be interested in knowing if an emergency call was made from their home. In addition to an emergency call, a parent or employer may also desire to be notified if a call was made from their home or business to a specific telephone number.

### SUMMARY

In one aspect, an alerting system is disclosed. In one embodiment, the alerting system includes: (1) a detection system configured to identify an initiated emergency call, identify a calling device initiating the emergency call and generate a detection message that identifies the calling device, the detection system implemented at central office equipment of a telephone company, (2) a determining system configured to receive the detection message, confirm if the calling device is registered with an alerting service and generate a confirmation message when the calling device is registered, the determining system configured to uniquely correspond with the telephone company and (3) a notification system configured to receive the confirmation message, determine parties associated with the calling device and contact the parties with a notification message, the notification message limited to information obtained concurrent with or before occurrence of the emergency call, the determining system and the notification system independent of the telephone company.

In another aspect, a method of alerting a subscriber is disclosed. In one embodiment, the method includes: (1) identifying, at central office equipment of a telephone company, initiation of a call that is directed to a pre-determined number, (2) generating at the central office equipment a detection message identifying a calling device initiating the call, (3) determining at a determination computing device configured to uniquely correspond with the telephone company, if the calling device is registered with an alerting service based on the detection message, the determination computing device independent of the telephone company, (4) generating a confirmation message at the determination computing device when determining the calling device is registered with the alerting service, (5) determining, at a notification computing device independent of the telephone company, parties associated with the calling device, (6) generating, at the notification computing device, at least one notification message employing the notification computing device to send to the parties and (7) sending the notification message to the parties, the notification message limited to information obtained concurrent with or before occurrence of the call.

In yet another aspect, an apparatus of an alerting service coupled to a network of a telephone company is disclosed. In one embodiment, the apparatus, includes: (1) a message transceiver configured to receive a detection message, generated at central office equipment of the telephone company, indicating a telephone call has been initiated to a pre-determined number and including an identifier for a calling device that initiated the telephone call and (2) an ascertainer coupled to the message transceiver and configured to compare the identifier with a database uniquely corresponding with the telephone company and generate a confirmation message when the calling device is a registered subscriber of an alerting service.

### BRIEF DESCRIPTION

Reference is now made to the following descriptions taken in conjunction with the accompanying drawings, in which:

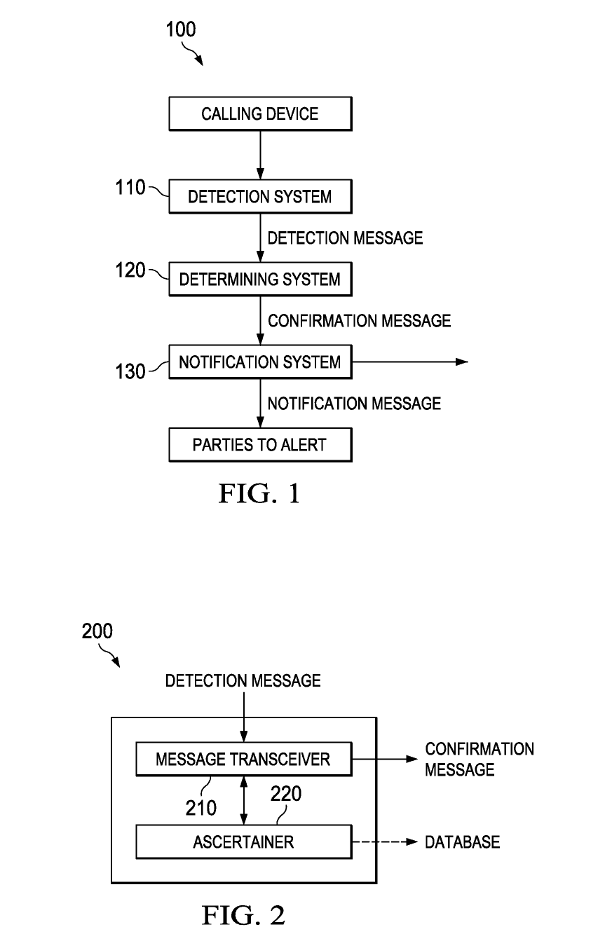

FIG. 1 is a block diagram of an embodiment of an alerting system constructed according to the principles of the disclosure;

FIG. 2 is a block diagram of an embodiment of a determining system constructed according to the principles of the disclosure;

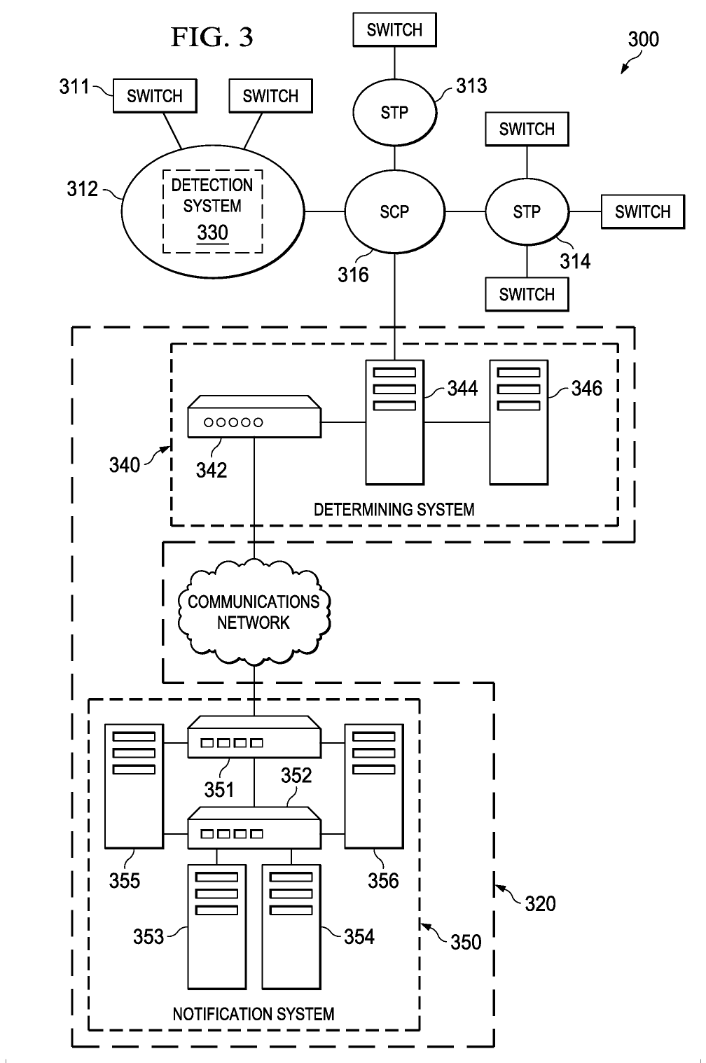

FIG. 3 is a system diagram of an embodiment of an alerting system constructed according to the principles of the disclosure and in the environment of a telecommunications network; and

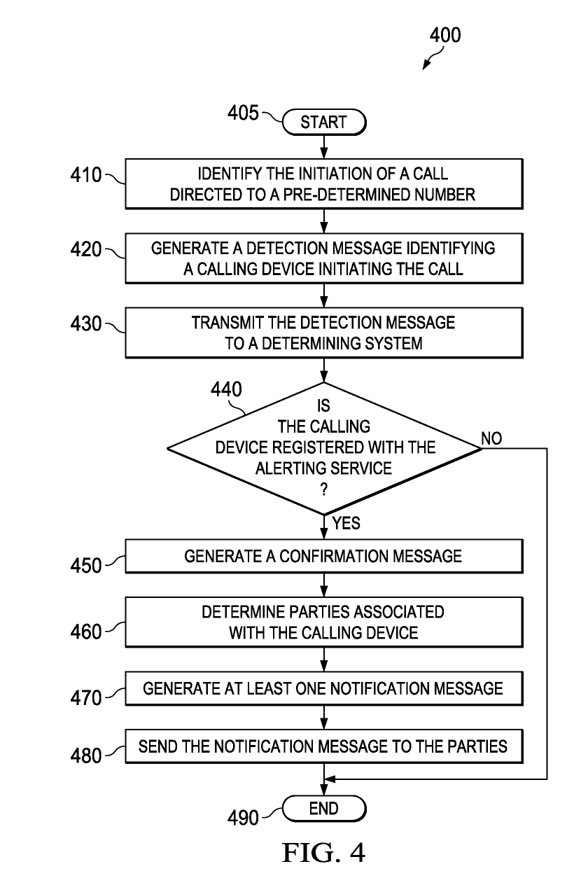

FIG. 4 is a flow diagram of an embodiment of a method of alerting a subscriber carried out according to the principles of the disclosure.

### DETAILED DESCRIPTION

FIG. 1 is a block diagram of an embodiment of an alerting system 100 constructed according to the principles of the disclosure. The alerting system 100 includes a detection system 110, a determining system 120 and a notification system 130.

The alerting system 100 is configured to identify initiated calls directed to pre-determined telephone numbers and notify a subscriber if the call was initiated from a calling device that is registered with an alerting service. The pre-determined telephone number may be a telephone number associated with an emergency response system. In some embodiments, the pre-determined telephone number may be a telephone number a parent or employer desires to be monitored. The alerting system 100 may monitor multiple telephone numbers for a particular calling device and contact different parties based on the telephone number that was called.

The initiated call may be considered an inbound telephone call. An inbound telephone call is a telephone call that has been placed or initiated over a telecommunications network of a telephone company and is still within the telephone company's telecommunication network. In other words, the telephone call has not been delivered out of the telecommunications network (off-network). As such, an initiated emergency call is a telephone call that has been placed or initiated to an emergency response system over a telecommunications network of a telephone company and still is within the telephone company's telecommunication network. In other words, the telephone call has not been delivered out of the telecommunications network (off-network) to the emergency response system (e.g., Public Safety Answering Point (PSAP)).

The detection system 100 is configured to identify that an initiated call to a pre-determined number has been initiated and identify the calling device initiating the call. The initiated call is received at a central office switch of a telephone company. In one embodiment, the detection system 100 may be implemented on the receiving central office switch. In other embodiments, the detection system 100 may be implemented on other equipment at the central office including, for example, signaling equipment for the telecommunications network of the telephone company. In one embodiment, the detection system 100 may be implemented at a Signal Transfer Point (STP). The STP may be a router that is configured (e.g., programmed) to detect the initiated call, generate a detection message that identifies the calling device and transmit the detection message to the determining system 120.

As noted above, the central office switch may be the first or originating switch of the telephone company that receives the initiated call. The central office switch may be an Advanced Intelligent Network (AIN) switch of the telecommunications network. A telephone number of the emergency response system may be used as an AIN trigger to identify that the initiated call has been made to a monitored telephone number. The central office switch may be programmed to monitor for calls directed to the pre-determined number. For example, an AIN trigger for all calls directed to an emergency response system (e.g., a 911 call) may be established. The detection system 110 may also be implemented on other equipment capable of employing AIN triggers.

The detection system 100 is also configured to generate the detection message that identifies the calling device that initiated the call. The calling device, for example, may be a landline telephone and the detection message may include the telephone number of the landline telephone to identify the landline telephone. Besides the telephone number, the detection message may include the date, time or type of call (e.g., an emergency call, long distance call, 900 call, tracking a commercial effectiveness call, etc.). In one embodiment, the detection system 110 is configured to transmit the detection message to the determining system 120 via a signaling network of the telecommunications network of the telephone company.

The determining system 120 is configured to receive the detection message and confirm if the calling device is registered with an alerting service. If the calling device is registered with the alerting service, the determining system 120 is further configured to generate a confirmation message. The confirmation message at least identifies the calling device and is transmitted to the notification system 130. The calling device may be identified via an Automatic Number Identifier (ANI). Additionally, the confirmation message may also include the time and date the initiated call was made. In some embodiments, the confirmation message may be formatted to transmit over a Virtual Private Network (VPN) to the notification system 130.

The determining system 120 is configured to uniquely correspond with the telephone company. In other words, the determining system 120 is designed to be specific to a single telephone company. Thus, the determining system 120 is configured to correspond to the format and configuration requirements of the telephone company and may only include those calling devices of the telephone company that are registered. In some embodiments, a single determining system 120 is employed for a particular telephone company. The determining system 120 may be implemented on a single computing device that is independent of (i.e., not owned by) the telephone company. As such, the determining system 120 may be implemented on a single computing device that is coupled to the telecommunications network of the telephone company.

Though the determining system 120 is configured to uniquely correspond with the telephone company, the determining system does not rely on queries to databases owned by the telephone company, such as, an Automatic Location Identification (ALI) database. On the contrary, the alerting system 100 is not concerned with the relationship between calling devices and the physical address associated with the calling device. Instead, the alerting system 100 is configured to identify initiated calls directed to pre-determined telephone numbers and notify a subscriber if the call was initiated from a calling device that is registered with an alerting service. Thus, the alerting system 100 will work in telephone systems that do not use an ALI database. Accordingly, the alerting system is adaptable for various telephone numbers called; not just telephone numbers associated with ALI databases.

The notification system 130 is configured to receive the confirmation message that was generated by the determining system 120 and determine parties associated with the calling device. The notification system 130 may receive the confirmation message from the determining system 120 over the Internet employing the VPN. The notification system 130 is further configured to contact (which includes initiating contact) the parties with a notification message. The notification message is limited to information obtained concurrent with or before occurrence of the initiated call. Like the determining system 120, the notification system 130 may also be implemented on a computing device or devices. As with the determining system 120, the notification system 130 is third-party equipment that is independent of the telephone company. The notification system 130 may be located remotely from a central office of the telephone company or from telephone company equipment.

FIG. 2 is a block diagram of an embodiment of a determining system 200 constructed according to the principles of the disclosure. The determining system 200 may be implemented as a computer device of an alerting service that is coupled to a signaling network for a telecommunications network of a telephone company. At least a part of the determining system 200 may be implemented on a processor as a series of operating instructions that direct the operation of the processor when initiated thereby. The determining system 200 includes a message transceiver 210 and an ascertainer 220.

The message transceiver 210 is configured to receive a detection message that indicates a telephone call has been initiated to a pre-determined number. For example, the pre-determined number may be an emergency response telephone number. The detection message includes an identifier for a calling device that initiated the emergency telephone call. The identifier may be the telephone number of the calling device. The detection message may be generated at a central office switch of a telephone company and received via a signaling network coupled to the central office switch. In one embodiment, the message transceiver 210 may be configured to receive the detection message from a Service Control Point (SCP) of the signaling network. A local area network (LAN) may be used to couple the SCP and message transceiver 210. In one embodiment, an Ethernet connection may be employed for the LAN. The message transceiver 210 may be coupled to the SCP via an ISDN User Part (ISUP) interface.

The message transceiver 210 is also configured to transmit a confirmation message. Thus, the message transceiver 210 is configured to communicate (receive and transmit) the detection message and the confirmation message. The confirmation message may be transmitted to a notification system of the alerting system. The message transceiver 210 may be configured to transmit the confirmation message via a communications network, such as the Internet. In one embodiment, the message transceiver 210 may transmit the confirmation message as an XML message over a VPN.

The ascertainer 220 is coupled to the message transceiver 210 and configured to compare the identifier with a database that uniquely corresponds with the telephone company. Based on the comparison, the ascertainer 220 is configured to generate the confirmation message when the calling device is a registered subscriber of the alerting service. In some embodiments, the database and the ascertainer 220 may be implemented in the same computing device. In other embodiments, the ascertainer 220 and the database may be located in different computing devices (as represented by the dashed line in FIG. 2).

FIG. 3 is a system diagram of an embodiment of an alerting system 320 constructed according to the principles of the disclosure and in the environment of a telecommunications network 300. The telecommunications network 300 includes components of a telephone company. The telecommunications network 300 includes multiple telephone switches including the denoted switch 312. The telecommunications network 300 also includes signaling components including STPs 312, 313, 314, and a SCP 316.

The telephone switches of FIG. 3 may be AIN switches that are configured to perform conventional switching in a telecommunications network. For example, the telephone switches may be Digital Multiplex System (DMS) telephone exchange switches from Nortel. The telephone switch 311 and the associated discussion may represent the other illustrated switches in FIG. 3.

The STPs 312, 313, 314, and the SCP 316 may be configured to provide Signaling System 7 (SS7) signaling functionality as typically provided in a conventional telecommunications network. For example, the STPs 312, 313, 314, may be routers that relay messages between components, such as signaling end points (SEPs), to provide and maintain telephone service. The multiple STPs 312, 313, 314, are each coupled to the SCP 316. The SCP 316 is used to control the telephone service and direct a telephone call. The SCP 316 may query a database to identify the geographical number to which a call is to be routed. The STPs 312, 313, 314, and the SCP 316 may be located in one or multiple central offices of the telecommunication network 310.

The alerting system 320 includes a detection system 330, a determining system 340 and a notification system 350 (indicated by dashed lines in FIG. 3). As illustrated in FIG. 3, the STP 312 includes the detection system 330. In this embodiment, the detection system 330 may be implemented as a series of operating instructions that direct the operation of the STP 312 when initiated thereby to identify a telephone call that is directed to a pre-determined number, generate a detection message and send the detection message to the determining system 340.

The determining system 340 is coupled to the SCP 316. In some embodiments, the determining system 316 may be coupled to the SCP 316 via an ISUP interface. The determining system 340 may be co-located in a central office of the telephone company with the SCP 316. In other embodiments, at least a portion of the determining system 340 may be located remotely from the SCP 316.

The determining system 340 includes a middleware server 344, a subscriber database 346 and a firewall 348. The middleware server 344 is configured to receive the detection message and compare the calling device identifier of the detection message with the subscriber database 346 to determine if the calling device is registered with the alerting system. If the middleware server 344 determines the calling device is registered, the middleware server 344 generates a confirmation message and transmits the confirmation message to the notification system 350. The middleware server 344 transmits the confirmation message to the notification system 350 via the firewall 342.

The notification system 350 includes a firewall 351, a switch 352, a server 353, a database 354, a contacter 355 and a subscriber interface 356. The firewall 351, like the firewall 342, is a conventional firewall that protects the notification system 350 from inbound data. Each firewall 342, 351, are coupled to a communications network, such as, the Internet. The switch 352 may be a conventional switch that directs traffic between the various components coupled thereto. The server 353 may be a conventional server that processes the inbound confirmation message and determines the parties to be contacted. The server 353 may determine the parties to contact by querying the database 354. The database 354 may be a conventional database that stores the various parties and associated contact information for the calling devices. The server 353 may direct the contacter 355 to contact the various parties. The contacter 355 may be a LINUX based computer that is configured to seize VOIP trunks via the public Internet when instructed thereby and complete the outbound calls to the parties. The subscriber interface 356 may also be coupled to the public Internet via the firewall 351 and be configured to allow subscribers to program dialing instructions and messages to the designated parties. The subscriber interface 356 may also allow subscribers to program how the various parties are to be contacted. The parties may all be contacted the same way (e.g., telephone calls) or parties may be contacted differently. For example, one party may be contacted via a telephone call, another one via an e-mail and yet still another one via a text message. A single party may also be contacted via multiple mediums. For example, a single party may be contacted via a text message, a telephone call or calls to different numbers and a multi-media message. Additionally, the single party could be contacted via a social media network such as Facebook or Twitter.

FIG. 4 is a flow diagram of an embodiment of a method 400 of alerting a subscriber carried out according to the principles of the disclosure. At least a portion of the method 400 may be carried out by various computing devices of an alerting system. The method 400 begins in a step 405.

In a step 410, initiation of a call that is directed to a pre-determined number is identified. The initiated call may be identified at a central office switch of a telephone company. In one embodiment, the predetermined number may be a telephone number of an emergency response system. In another embodiment, the pre-determined number is a telephone number that has been selected to be monitored. A user, such as the owner of a calling device initiating the call, may select a telephone number or numbers to be monitored. An AIN trigger may be employed to identify the initiation of the call. The AIN trigger may be based on the telephone number input via the calling device, i.e., the called telephone number.

A detection message identifying a calling device initiating the call is generated in a step 420. In a step 430, the detection message is transmitted to a determining system. The detection message may include a telephone number associated with the calling device that is used to identify the calling device.

In a decisional step 440, a determination is then made if the calling device is registered with the alerting service based on the detection message. The determination may be made at a determining system that uniquely corresponds with the telephone company. The determination may be made by comparing the telephone number of the calling device with a registration database that includes calling devices registered with the alerting service.

If the calling device is registered with the alerting service, a confirmation message is generated in a step 450. The confirmation message may be generated by the determining system. The confirmation message may include a date and time the call was initiated and an identifier of the calling device. The telephone number of the calling device may be used as an identifier. Alternatively, a unique identifier provided by the alerting system may be used as the identifier.

In a step 460, parties associated with the calling device are determined. A party may be people, entities, or devices to be contacted when the calling device initiates a call to a pre-determined telephone number or numbers. In one embodiment, an entity may be a monitoring company that is used to collect information associated with when the pre-determined number is called by the calling device or even multiple calling devices. For example, an advertising agency may want to collect information to determine the effectiveness of a commercial. The call may be categorized into different types of calls for processing by the advertising agency. The parties or party may be determined by a notification system that is independent of the telephone company.

After determining the party or parties to contact, at least one notification message is generated in a step 470. The notification message may be limited to information that is obtained concurrent with or before occurrence of the call. The notification message is then sent to the party or parties in a step 480.

In one embodiment, the notification message is sent as a telephone call. In other embodiments, the notification message may be sent as an e-mail, a text message or a multimedia message. In some embodiments, the notification message may be sent via a social media network, such as Twitter or Facebook. The method 400 then continues to step 490 and ends. Returning now to the decisional step 440, if the calling device is not registered with the alerting system, then the method 400 continues to step 490 and ends.

Those skilled in the art to which this application relates will appreciate that other and further additions, deletions, substitutions and modifications may be made to the described embodiments.

What is claimed is:

1. An alerting system, comprising:
a detection system configured to identify an initiated emergency call, identify a calling device initiating said emergency call and generate a detection message that identifies said calling device, said detection system implemented at central office equipment of a telephone company;
a determining system configured to receive said detection message, confirm if said calling device is registered with an alerting service and generate a confirmation message when said calling device is registered, said determining system configured to uniquely correspond with said telephone company; and
a notification system configured to receive said confirmation message, determine parties associated with said calling device and contact said parties with a notification message, said notification message limited to information obtained concurrent with or before occurrence of said emergency call, said determining system and said notification system independent of said telephone company.

2. The alerting system as recited in claim 1 wherein said detection system identifies said emergency call as an inbound call of said telephone company.

3. The alerting system as recited in claim 1 wherein said detection system employs an AIN trigger to identify said emergency call.

4. The alerting system as recited in claim 1 wherein said detection system identifies said emergency call by a telephone number.

5. The alerting system as recited in claim 1 wherein said determining system includes a registration database that indicates calling devices registered with said alerting service.

6. The alerting system as recited in claim 1 wherein said central office equipment is a AIN central office switch.

7. The alerting system as recited in claim 1 wherein said notification system is remotely located from said determining system.

8. The alerting system as recited in claim 1 wherein said notification system includes a contact database configured to store contact information for said parties.

9. The alerting system as recited in claim 1 wherein said notification system includes a registered user interface configured to receive and update contact information for said parties.

10. The alerting system as recited in claim 1 wherein said notification system is configured to contact said parties via a social media network.

11. A method of alerting a subscriber, comprising:
identifying, at central office equipment of a telephone company, initiation of a call that is directed to a pre-determined number;
generating at said central office equipment a detection message identifying a calling device initiating said call;
determining at a determination computing device configured to uniquely correspond with said telephone company, if said calling device is registered with an alerting service based on said detection message, said determination computing device independent of said telephone company;
generating a confirmation message at said determination computing device when determining said calling device is registered with said alerting service;
determining, at a notification computing device independent of said telephone company, parties associated with said calling device;
generating, at said notification computing device, at least one notification message employing said notification computing device to send to said parties; and
sending said notification message to said parties, said notification message limited to information obtained concurrent with or before occurrence of said call.

12. The method as recited in claim 11 wherein said identifying includes employing an AIN trigger to identify said initiation of said call.

13. The method as recited in claim 12 wherein said identifying is based on a telephone number input via said calling device.

14. The method as recited in claim 11 wherein said determining if said calling device is registered includes examining a registration database that includes calling devices registered with said alerting service.

15. The method as recited in claim 11 further comprising transmitting said detection message to said determination computing device, said detection message including a telephone number associated with said calling device.

16. The method as recited in claim 11 wherein said confirmation message includes a date and time said call was initiated and an identifier of said calling device.

17. The method as recited in claim 11 wherein said notification message is a telephone call.

18. The method as recited in claim 11 wherein said notification message is sent via a social media network.

19. The method as recited in claim 11 wherein said predetermined number is a telephone number of an emergency response system.

20. An apparatus of an alerting service coupled to a network of a telephone company, comprising:
a message transceiver configured to receive a detection message, generated at central office equipment of said telephone company, indicating a telephone call has been initiated to a pre-determined number and including an identifier for a calling device that initiated said telephone call; and
an ascertainer coupled to said message transceiver and configured to compare said identifier with a database uniquely corresponding with said telephone company and generate a confirmation message when said calling device is a registered subscriber of an alerting service.

21. The apparatus as recited in claim 20 wherein said message transceiver is further configured to send said confirmation message to a notification system that is independent of said telephone company.
